(19) United States
(12) Patent Application Publication
(10) Pub. No.: US 2010/0131723 A1
(43) Pub. Date: May 27, 2010

(54) ACCESS CONTROL APPARATUS, ACCESS CONTROL METHOD, AND STORAGE APPARATUS

(75) Inventor: Keiichi Yorimitsu, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/568,338

(22) Filed: Sep. 28, 2009

(30) Foreign Application Priority Data
Nov. 21, 2008 (JP) 2008-298589

(51) Int. Cl. G06F 12/00; G06F 12/10

(52) U.S. Cl. 711/154; 711/203; 711/E12.001; 711/E12.058

(57) ABSTRACT

According to one embodiment, an access control apparatus is configured to convert a logical address into position information of a physical sector to control access to a storage medium. The access control apparatus includes an access mode specifying command processing module and an access processing module. The access mode specifying command processing module receives an access mode specifying command specifying an access mode that defines a relationship between the logical address and the physical sector, and stores the access mode in an access mode storage module. The access processing module refers to the access mode storage module to determine an access mode for accessing the storage medium.

### CROSS-REFERENCE TO RELATED APPLICATIONS

This application is based upon and claims the benefit of priority from Japanese Patent Application No. 2008-298589, filed on Nov. 21, 2008, the entire contents of which are incorporated herein by reference.

### BACKGROUND

1. Field

One embodiment of the invention relates to an access control apparatus, an access control method, and a storage apparatus for converting a logical address into position information of a physical sector to control access to a storage medium.

2. Description of the Related Art

In a magnetic disk apparatus or the like, access has been controlled by assigning a logical access sequence (logical block) to predetermined physical sectors.

Generally, as a rule for assigning a logical address (a logical block number) to the above physical sectors (LBA: logical block addressing), i.e., as an access mode, one pattern of access mode is employed for each generation or version of apparatus. Assignment of a logical address to physical sectors depends on firmware in a control apparatus, and the assignment is determined before shipping from factory. Commands for accessing a storage medium from a host apparatus are standardized to improve compatibility with conventional models or the like.

Such a standardized access mode for storage media means that data on a storage medium can be read easily even by a third person other than a valid purchaser. Therefore, preventive measures against data leakage have been considered. For example, technologies in which write data is encrypted by an encryption key and in which unauthorized access is prevented by attaching additional security information (data integrity field, etc.) to data have been used. Reference may be had to, for example, Japanese Patent Application Publication (KOKAI) No. H2-29837.

However, the data encryption requires additional hardware, resulting in an expensive apparatus. In addition, complexity of control increases because a password control is required to manage the encryption key, and the storage method of the password and the encryption key requires confidentiality.

When adding management additional information, extra information has to be added to data. This increases recording density and, as a result, the yield ratio of the apparatus decreases.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a configuration of a magnetic storage apparatus according to an embodiment of the invention;

FIG. 2 is an exemplary flowchart of a process of formatting a magnetic disk in the embodiment;

FIG. 3 is an exemplary flowchart of an access mode setting process performed by an access mode specifying command processing module in the embodiment;

FIG. 4 is an exemplary flowchart of write operation performed by a write command processing module in the embodiment;

FIG. 5 is an exemplary flowchart of read operation performed by a read command processing module in the embodiment;

FIG. 6 is an exemplary schematic diagram for explaining a structure of a magnetic disk in the embodiment;

FIG. 7 is an exemplary schematic diagram for explaining the recording surface of the magnetic disk in the embodiment.

FIG. 8 is an exemplary schematic diagram of a configuration of heads and tracks in the embodiment;

FIG. 9 is an exemplary schematic diagram for explaining the assignment order of logical addresses in a head-to-head moving format in the embodiment;

FIG. 10 is an exemplary schematic diagram for explaining the assignment order of logical addresses in a surface-to-surface moving squared U-shaped format in the embodiment;

FIG. 11 is an exemplary schematic diagram for explaining the assignment order of logical addresses in a surface-to-surface moving squared U-shaped format which is separated for each cell in the embodiment;

FIG. 12 is an exemplary schematic diagram for explaining the assignment order of logical addresses in a surface-to-surface moving Z-shaped format in the embodiment;

FIG. 13 is an exemplary schematic diagram for explaining the assignment order of logical addresses in a surface-to-surface moving Z-shaped format which is separated for each cell in the embodiment;

FIG. 14 is an exemplary schematic diagram for explaining logical address assignment to physical sectors in the head-to-head moving format in the embodiment;

FIG. 15 is an exemplary schematic diagram for explaining logical address assignment to physical sectors in the surface-to-surface moving Z-shaped format with cell division in the embodiment;

FIG. 16 is an exemplary schematic diagram for explaining a variation of assignment destinations of logical addresses depending on the difference in the format in the embodiment; and

FIG. 17 is an exemplary schematic diagram for explaining the format of physical sectors in the embodiment.

### DETAILED DESCRIPTION

Various embodiments according to the invention will be described hereinafter with reference to the accompanying drawings. In general, according to one embodiment of the invention, an access control apparatus is configured to convert a logical address into position information of a physical sector to control access to a storage medium. The access control apparatus comprises an access mode specifying command processing module and an access processing module. The access mode specifying command processing module is configured to receive an access mode specifying command specifying an access mode that defines a relationship between the logical address and the physical sector, and store the access mode in an access mode storage module. The access processing module is configured to refer to the access mode storage module to determine an access mode for accessing the storage medium.

According to another embodiment of the invention, There is provided an access control method for controlling access to a storage medium by converting a logical address into position information of a physical sector. The access control method comprises: an access mode specifying command processing module receiving an access mode specifying command specifying an access mode that defines a relationship between the logical address and the physical sector, and storing the access mode in an access mode storage module; and an access processing module referring to the access mode storage module to determine an access mode for accessing the storage medium.

According to still another embodiment of the invention, a storage apparatus comprises an access controller configured to convert a logical address specified by a host into position information of a physical sector to control an access request to a storage medium including a plurality of recording surfaces when receiving the access request from the host. The access controller comprises an access mode specifying command processing module and an access processing module. The access mode specifying command processing module is configured to receive an access mode specifying command specifying an access mode that defines a relationship between the logical address and the physical sector, and store the access mode in an access mode storage module. The access processing module is configured to refer to the access mode storage module to determine an access mode for accessing the storage medium.

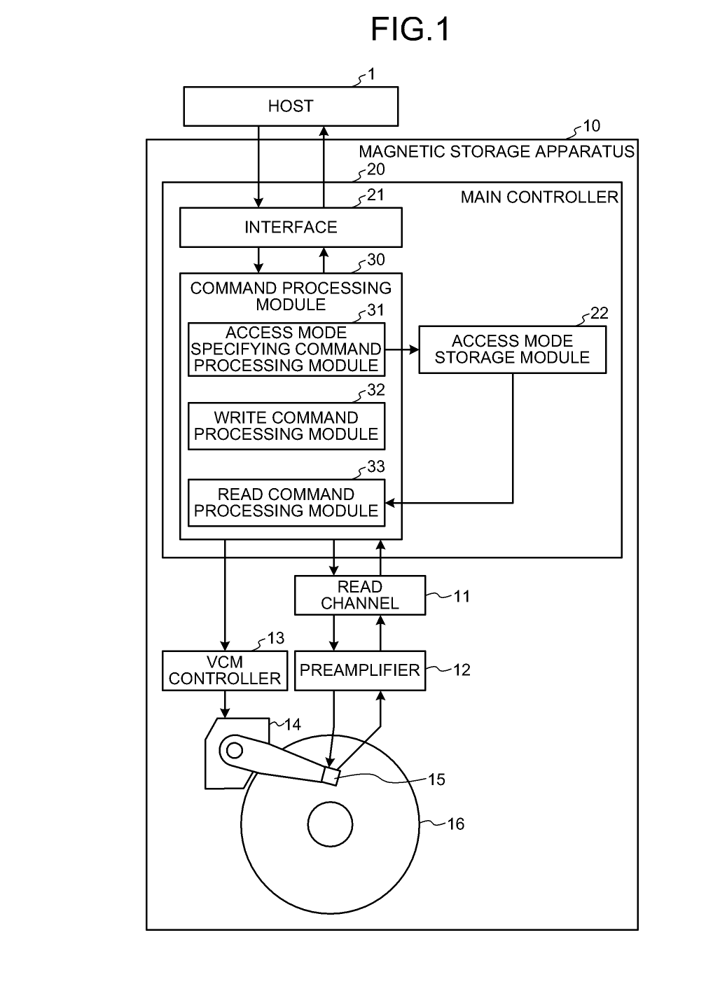

FIG. 1 is a schematic diagram of a configuration of a magnetic storage apparatus 10 according to an embodiment of the invention. As illustrated in FIG. 1, the magnetic storage apparatus 10 comprises a main controller 20, a magnetic head 15, a voice coil motor (VCM) 14, a VCM controller 13, a preamplifier 12, and a read channel 11 in addition to a magnetic disk 16, i.e., a storage medium.

The magnetic disk 16 comprises a plurality of magnetic recording surfaces and a plurality of magnetic heads corresponding to the magnetic recording surfaces, and is initialized with a specific access mode before shipping from factory. This access mode defines a relationship between a logical address and a physical sector, and specifically defines the assignment order of logical addresses to physical sectors included in the magnetic recording surfaces.

The magnetic head 15 is subjected to position control by the VCM 14 with respect to the magnetic disk 16, and writes magnetic data to or reads magnetic data from the magnetic disk 16. The VCM controller 13 receives a control signal from the main controller 20 and controls the operation of the VCM 14, thereby performing the position control of the magnetic head 15.

The preamplifier 12 amplifies a reproduction signal which the magnetic head 15 reads from the magnetic disk 16, and output the reproduction signal to the read channel 11. The preamplifier 12 also amplifies a write current when the magnetic head 15 writes magnetic data to the magnetic disk 16.

The read channel 11 amplifies the reproduction signal inputted from the preamplifier 12, and performs processing for maintaining amplitude of the reproduction signal at a constant level, AD conversion processing of the reproduction signal, demodulation processing of the reproduction signal, and the like, and thereafter outputs the reproduction signal to the main controller 20. When receiving an input of write information from the main controller 20, the read channel 11 performs code modulation of magnetic data to be written and outputs the magnetic data to the preamplifier 12.

The main controller 20 is a controller for integrally controlling the entire magnetic storage apparatus 10, and functions as an access controller. The main controller comprises, inside thereof, an interface 21, a command processing module 30, and an access mode storage module 22.

The interface 21 is a processing module for communicating with a host 1 or the like which are an external apparatus of the magnetic storage apparatus 10, and the interface 21 receives various commands from the host and transmits the execution results of the commands.

The command processing module 30 is a processing module which performs processing for executing the various commands received from the host 1, and is a function module realized by, for example, an MPU executing firmware. The command processing module 30 comprises, inside thereof, a access mode specifying command processing module 31, a write command processing module 32, and a read command processing module 33.

When receiving an access mode specifying command for specifying an access mode from the host 1, the access mode specifying command processing module 31 accepts the access mode specifying command and performs processing for storing the specified access mode to the access mode storage module 22.

The write command processing module 32 is a processing module for processing a write command received from the host 1. The write command includes data to be written and an address of write destination, and the address is specified with a logical address. Therefore, the write command processing module 32 converts the logical address into position information of a physical sector, and writes data to the magnetic disk. Here, when performing address conversion of the logical address into position information of a physical sector, the write command processing module 32 performs conversion on the basis of an access mode applied when formatted.

The read command processing module 33 is a processing module for processing a read command received from the host 1. The read command includes an address of read source, and the address is specified with a logical address. Therefore, the read command processing module 33 converts the logical address into position information of a physical sector, and reads data from the magnetic disk. Here, when performing address conversion of the logical address into position information of a physical sector, the read command processing module 33 performs conversion on the basis of an access mode stored by the access mode storage module 22.

The read command which is open to users can access only by using a logical address, and control firmware calculates a physical track/physical head and physical sector (technically, the number of sectors from the top of the physical track/physical head) corresponding to a given logical address, and performs seek and read operations.

If the read access mode applied when a read command is executed does not match the write access mode applied upon writing, an error occurs. Therefore, if modes are set so that the read access mode does not match the write access mode in the initial state, data cannot be read unless the access mode specifying command is issued and an appropriate access mode is selected.

In this way, by using the error due to the mismatch of access modes, security for preventing unauthorized reading can be realized. In other words, since a valid purchaser knows that there is an access mode specifying command for changing the read access mode and also knows an appropriate read access mode, the valid purchaser can execute the read command normally by specifying the access mode specifying command before issuing the read command. On the other hand, a third person who tries to fraudulently read data from a magnetic storage apparatus does not know that the read access mode needs to be changed, and also does not know the appropriate read access mode. Accordingly, the third person cannot execute the read command normally.

When the access mode storage module 22 is made of a volatile memory, once an access mode is set after starting the magnetic recording apparatus, it is possible to read freely until power supply to the volatile memory is cut off, and it is also possible to prevent unauthorized access by turning off the magnetic recording apparatus to delete the registered access mode.

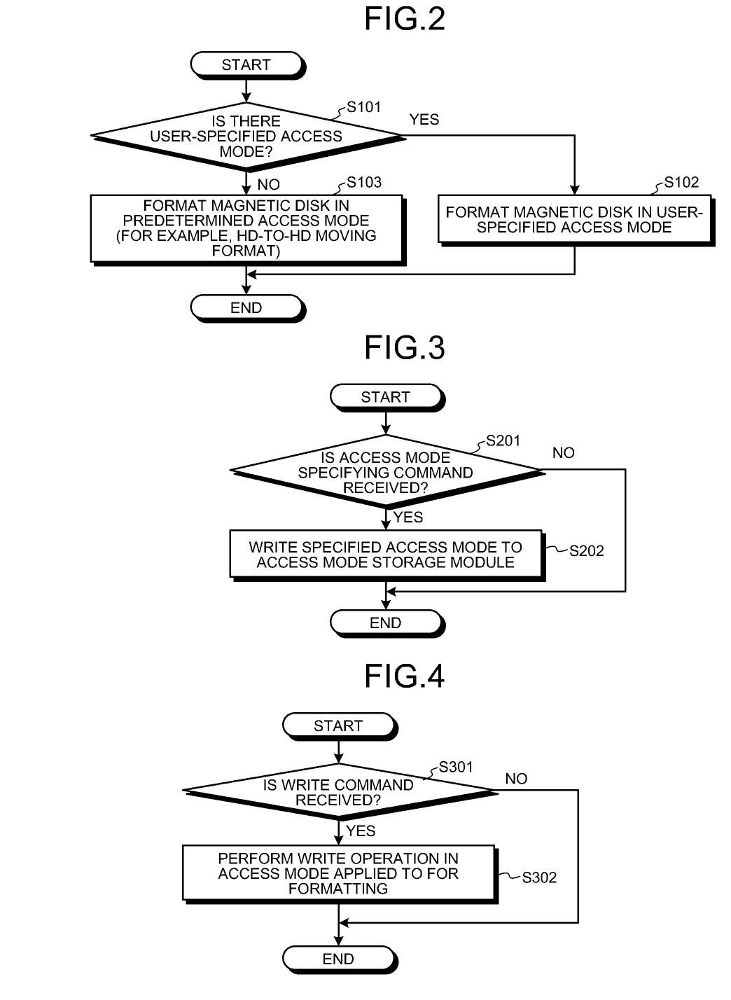

Next, with reference to FIGS. 2 to 5, various operations related to the magnetic storage apparatus 10 will be described. FIG. 2 is a flowchart of a process of formatting the magnetic disk. The magnetic storage apparatus 10 starts formatting illustrated in FIG. 2 when receiving a Format Unit command or the like in process in a factory before shipping. Also, the formatting can be performed by the customer or the like after shipping.

First, the magnetic storage apparatus 10 determines whether a write access mode specification is received from the customer (S101). As a result, when a write access mode specification is received from the customer (Yes at S101), the magnetic storage apparatus 10 formats the magnetic disk in the specified access mode (S102), and the process ends.

On the other hand, when a write access mode specification not is received from the customer (No at S101), the magnetic storage apparatus 10 formats the magnetic disk in a specific access mode (for example, with an access mode using a head-to-head moving format) (S103), and the process ends.

FIG. 3 is a flowchart of an access mode setting process performed by the access mode specifying command processing module 31. The access mode specifying command processing module 31 performs this process flow repeatedly.

As illustrated in FIG. 3, when not receiving an access mode specifying command (No at S201), the access mode specifying command processing module 31 does not perform particular processing, and the process ends. On the other hand, when receiving an access mode specifying command (Yes at S201), the access mode specifying command processing module 31 stores the specified access mode in the access mode storage module 22 (S202), and the process ends.

FIG. 4 is a flowchart of write operation performed by the write command processing module 32. The write command processing module 32 performs this process flow repeatedly.

As illustrated in FIG. 4, when not receiving a write command (No at S301), the write command processing module 32 does not perform particular processing, and the process ends. On the other hand, when receiving a write command (Yes at S301), the write command processing module 32 performs write operation in the write access mode applied to formatting (S302), and the process ends.

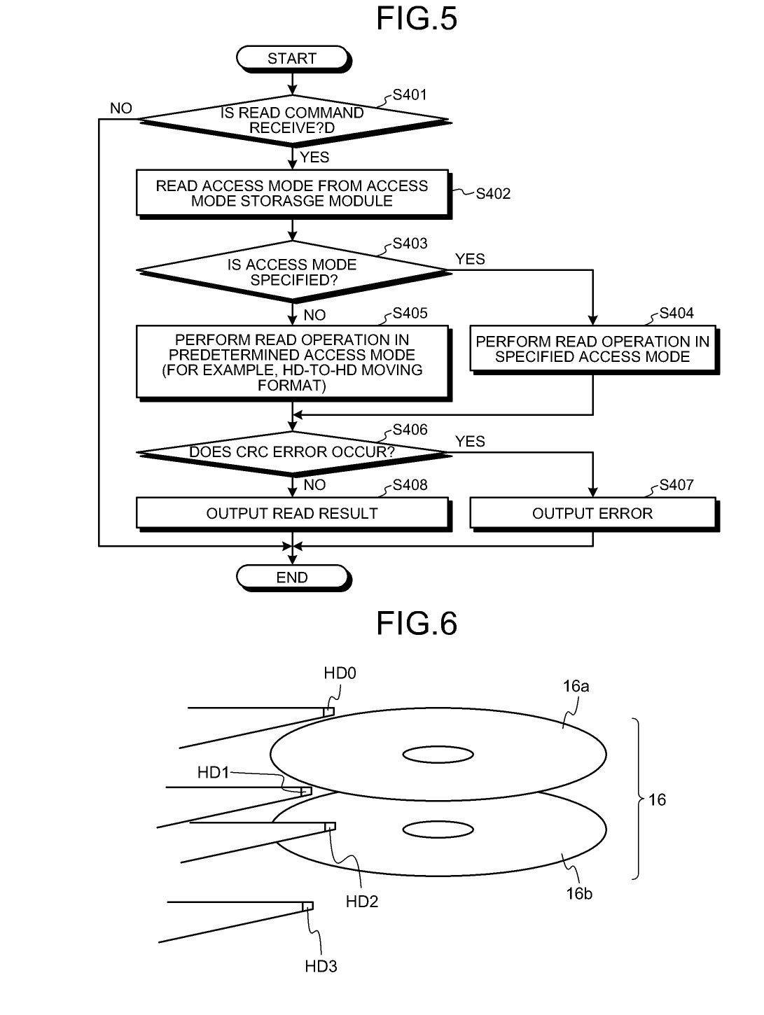

FIG. 5 is a flowchart of read operation performed by the read command processing module 33. The read command processing module 33 performs this process flow repeatedly.

As illustrated in FIG. 5, when not receiving a read command (No at S401), the read command processing module 33 does not perform particular processing, and the process ends. On the other hand, when receiving a read command (Yes at S401), the read command processing module 33 reads the access mode from the access mode storage module 22 (S402).

As a result, when the access mode is stored in the access mode storage module 22, in other words, when the access mode is specified (Yes at S403), the read command processing module 33 performs read operation in the specified access mode (S404).

On the other hand, when the access mode is not stored in the access mode storage module 22, in other words, when the access mode is not specified (No at S403), the read command processing module 33 performs read operation in a predetermined access mode (for example, an access mode using a head-to-head moving format (S405).

As a result of the read operation, when the read access mode and the write access mode do not match and a CRC error occurs (Yes at S406), the read command processing module 33 outputs the fact that the CRC error occurs (S407), and the process ends.

On the other hand, when the read access mode matches the write access mode, and a CRC error does not occur (No at S406). The read command processing module 33 outputs a read result (S408), and the process ends.

Next, the magnetic disk 16 will be described in detail. As illustrated in FIG. 6, the magnetic disk 16 comprises two disks, a disk 16a and a disk 16b. Both surfaces of the disks 16a and 16b can be used as recording surfaces. The magnetic head 15 comprises four heads, a head HD0, a head HD1, a head HD2, and a head HD3. The head HD0 is a head for writing on the upper surface of the disk 16a, and the head HD1 is a head for writing on the lower surface of the disk 16a. In the same way, the head HD2 is a head for writing on the upper surface of the disk 16b, and the head HD3 is a head for writing on the lower surface of the disk 16b.

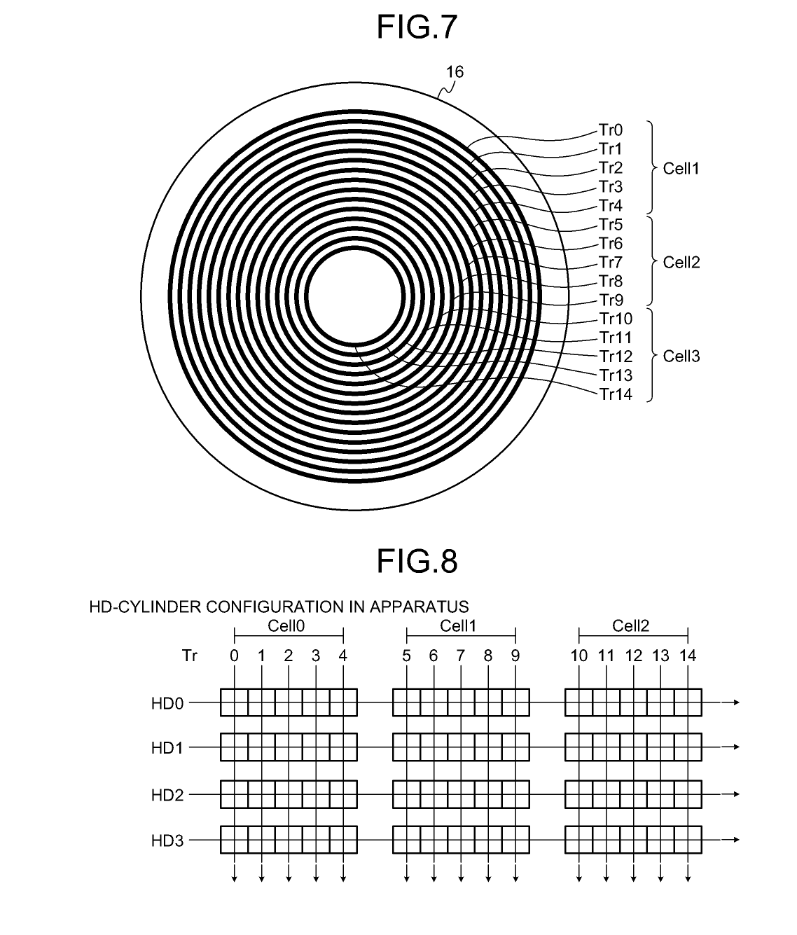

FIG. 7 illustrates the recording surface of the magnetic disk 16. Concentric tracks Tr0 to Tr14 are formed on each recording surface of the magnetic disk 16. This track is also called a cylinder. Further, each track is divided in a radial fashion to form physical sectors. This sector is a read/write unit of the magnetic disk 16. In the example of FIG. 7, a set of five tracks makes a cell. Specifically, the Tr0 to Tr4 are a Cell1, the Tr5 to Tr9 are a Cell2, and the Tr10 to Tr14 are a Cell3.

FIG. 8 is a schematic diagram of a configuration of the heads and tracks, and each of the heads HD0 to HD3 has corresponding tracks Tr0 to Tr14 respectively. In the formatting of the magnetic disk 16, logical addresses are assigned to the physical sectors included in these tracks.

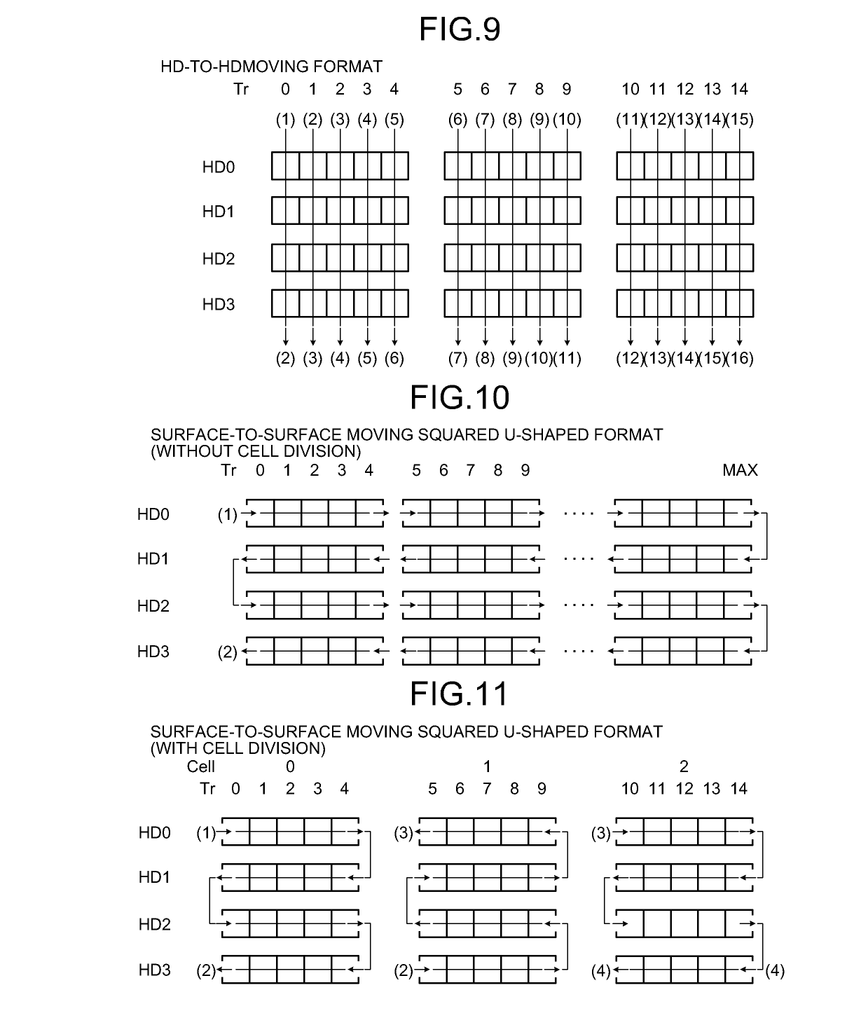

FIG. 9 illustrates the assignment order of logical addresses in the head-to-head moving format. The logical addresses are provided in ascending order in accordance with the providing sequence. In the head-to-head moving format, first, a logical address is provided to Tr0 of the head HD0, and thereafter, a logical address is provided to Tr0 of the head HD1 which is the next head. Thereafter, logical addresses are provided to Tr0 of the head HD2 and Tr0 of the head HD3. After logical addresses are provided to Tr0 of all the heads, the track is moved, and a logical address is provided to Tr1 of the head HD1. As described above, in the head-to-head moving format, after a logical address is assigned to one track, the track is moved to the same track of the next head, and after logical addresses are assigned to the same tracks of all the heads, the track is moved to the next track.

FIG. 10 illustrates the assignment order of logical addresses in a surface-to-surface moving squared U-shaped format. In the surface-to-surface moving squared U-shaped format, first, a logical address is provided to Tr0 of the head HD0, and thereafter, a logical address is provided to Tr1 of the head HD0 which is the next track. Thereafter, logical addresses are sequentially provided to Tr2 of the head HD0 and Tr3 of the head HD0.

After logical addresses are provided to all the tracks of the head HD0, a logical address is provided to the last track of the head HD1 which is the next head, and the track is moved from the last track toward Tr0. After a logical address is provided to Tr0 of the head HD1, logical addresses are sequentially provided to the tracks from Tr0 to the last track of the head HD2.

After logical addresses are provided to all the tracks of the head HD2, a logical address is provided to the last track of the head HD3 which is the next head, and the track is moved from the last track toward Tr0.

As described above, in the surface-to-surface moving squared U-shaped format, after a logical address is assigned to the first track, the track is moved sequentially by the same head, and after a logical address is assigned to the last track, the track is moved to the last track of the next head. After logical addresses are provided to the tracks from the last track to the first track, the track is moved to the first track of the next head, and logical addresses are provided.

The surface-to-surface moving squared U-shaped format can be performed separately for each cell. FIG. 11 illustrates the assignment order of logical addresses in the surface-to-surface moving squared U-shaped format which is separated for each cell. In the surface-to-surface moving squared U-shaped format which is separated for each cell, first, a logical address is provided to Tr0 of the head HD0, and thereafter, a logical address is provided to Tr1 of the head HD0 which is the next track. Thereafter, logical addresses are sequentially provided to Tr2 of the head HD0 and Tr3 of the head HD0, and after a logical address is provided to Tr4 which is the last track of the Cell0, logical addresses are provided sequentially to Tr4, Tr3, Tr2, Tr1, and Tr0 by the head HD1. Furthermore, logical addresses are provided sequentially to Tr0, Tr1, Tr2, Tr3, and Tr4 by the head HD2, and logical addresses are provided sequentially to Tr4, Tr3, Tr2, Tr1, and Tr0 by the head HD3.

As described above, first, logical addresses are provided to the Cell0 in the surface-to-surface moving squared U-shaped format, and thereafter, logical addresses are provided to the Cell1 and the Cell2 in the same way as the Cell0.

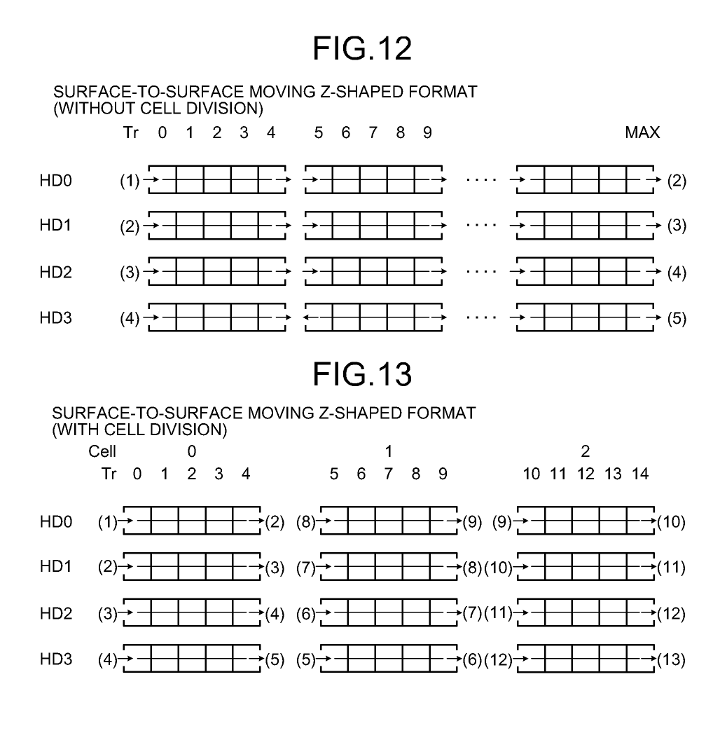

FIG. 12 illustrates the assignment order of logical addresses in a surface-to-surface moving Z-shaped format. In the surface-to-surface moving Z-shaped format, first, a logical address is provided to the first track Tr0 of the head HD0, and thereafter, a logical address is provided to Tr1 of the head HD0 which is the next track. Thereafter, logical addresses are sequentially provided to Tr2 of the head HD0 and Tr3 of the head HD0.

After logical addresses are provided to all the tracks of the head HD0, a logical address is provided to the first track Tr0 of the head HD1 which is the next head, and the track is moved from the first track toward the last track. After a logical address is provided to the last track of the head HD1, logical addresses are sequentially provided to the tracks from Tr0 to the last track of the head HD2, and thereafter, logical address are sequentially provided to the tracks from Tr0 to the last track of the head HD3.

As described above, in the surface-to-surface moving Z-shaped format, after a logical address is assigned to the first track, the track is moved sequentially by the same head, and after a logical address is assigned to the last track, the track is moved to the first track of the next head, and logical addresses are provided to the tracks from the first track toward the last track.

Also, the surface-to-surface moving Z-shaped format can be performed separately for each cell. FIG. 13 illustrates the assignment order of logical addresses in the surface-to-surface moving Z-shaped format which is separated for each cell. In the surface-to-surface moving Z-shaped format which is separated for each cell, first, a logical address is provided to Tr0 of the head HD0, and thereafter, a logical address is provided to Tr1 of the head HD0 which is the next track. Thereafter, logical addresses are sequentially provided to Tr2 of the head HD0 and Tr3 of the head HD0, and after a logical address is provided to Tr4 which is the last track of the Cell0, logical addresses are provided sequentially to Tr0, Tr1, Tr2, Tr3, and Tr4 by the head HD1. Furthermore, logical addresses are provided sequentially to Tr0, Tr1, Tr2, Tr3, and Tr4 by the head HD2, and logical addresses are provided sequentially to Tr0, Tr1, Tr2, Tr3, and Tr4 by the head HD3.

As described above, first, logical addresses are provided to the Cell0 in the surface-to-surface moving Z-shaped format, and thereafter, logical addresses are provided to the Cell1 and the Cell2 in the same way as the Cell0.

In this way, the sequence of assigning logical addresses to the physical sectors varies depending on the format specified by the access mode. Therefore, the physical sectors correspond to different logical addresses depending on the format.

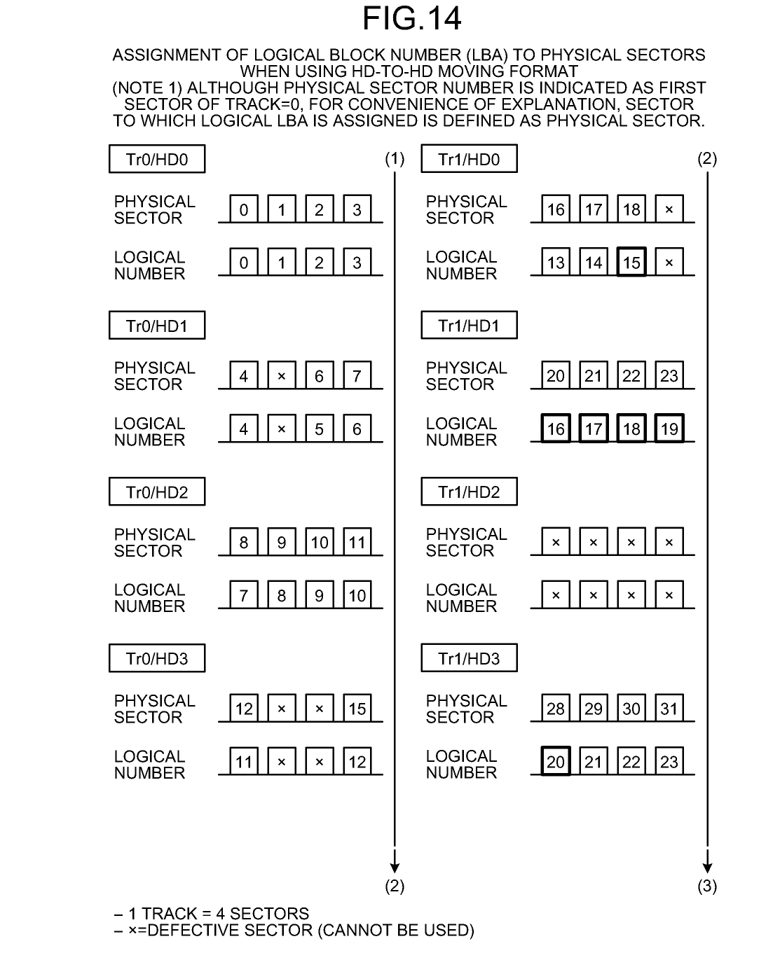

FIG. 14 illustrates the logical address assignment to the physical sectors in the head-to-head moving format. Normally, as for the physical sector number, the first sector in a track is “0”. However, for convenience of description, serial numbers are assigned to the physical sectors in accordance with the assignment order of logical addresses. As for the serial numbers of physical sectors, numbers are assigned regardless of whether there is a sector defect, in other words, whether the sectors are available. In the example of FIG. 14, the case where four sectors are formed in one track will be described as an example.

First, the physical sectors formed in the track Tr0 of the head HD0 are all normal, and logical addresses 0 to 3 are assigned to them. Next, since the sector of serial number 5 in the physical sectors formed in the track Tr0 of the head HD1 is a defective sector, logical addresses 4 to 6 are assigned to the three sectors except for the defective sector.

The physical sectors formed in the track Tr0 of the head HD2 are all normal, and logical addresses 7 to 10 are assigned to them. Next, since the sectors of serial numbers 13 and 14 in the physical sectors formed in the track Tr0 of the head HD3 are defective sectors, logical addresses 11 and 12 are assigned to the two sectors except for the defective sectors.

Similarly, since the sector of serial number 19 in the physical sectors formed in the track Tr1 of the head HD0 is a defective sector, logical addresses 13 to 15 are assigned to the three sectors except for the defective sector. Next, the physical sectors formed in the track Tr1 of the head HD1 are all normal, and logical addresses 16 to 19 are assigned to them.

The physical sectors formed in the track Tr1 of the head HD2 are all defective sectors, and logical addresses are not assigned to them. Next, the physical sectors formed in the track Tr1 of the head HD3 are all normal, and logical addresses 20 to 23 are assigned to them.

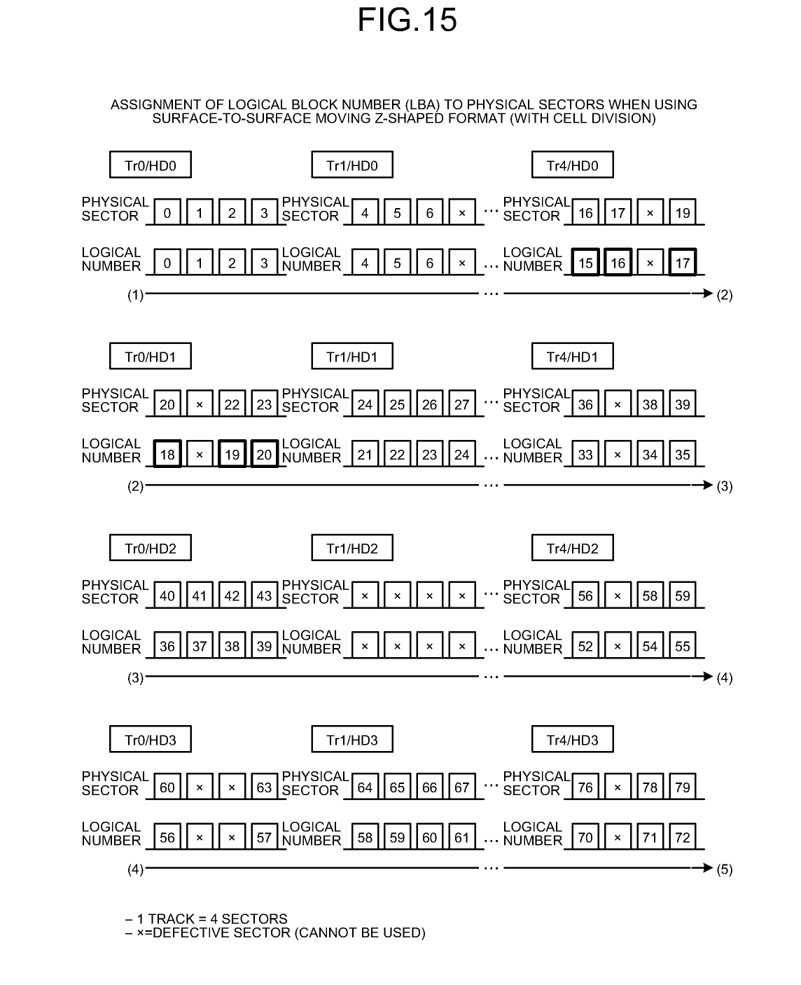

FIG. 15 illustrates the logical address assignment to the physical sectors in the surface-to-surface moving Z-shaped format with cell division. In FIG. 15, serial numbers are assigned to the physical sectors in accordance with the assignment order of logical addresses regardless of whether there is a defect in the physical sectors, and four sectors are formed in one track.

First, the physical sectors formed in the track Tr0 of the head HD0 are all normal, and logical addresses 0 to 3 are assigned to them. Next, since the sector of serial number 7 in the physical sectors formed in the track Tr1 of the head HD0 is a defective sector, logical addresses 4 to 6 are assigned to the three sectors except for the defective sector. When similar assignments are continuously performed, since the sector of serial number 18 in the physical sectors formed in the track Tr4 of the head HD0 is a defective sector, logical addresses 15 to 17 are assigned to the three sectors except for the defective sector.

Next, since the sector of serial number 21 in the physical sectors formed in the track Tr0 of the head HD1 is a defective sector, logical addresses 18 to 20 are assigned to the three sectors except for the defective sector. Since the physical sectors formed in the track Tr1 of the head HD1 are all normal, logical addresses 21 to 24 are assigned to them. When similar assignments are continuously performed, since the sector of serial number 37 in the physical sectors formed in the track Tr4 of the head HD1 is a defective sector, logical addresses 33 to 35 are assigned to the three sectors except for the defective sector.

Next, the physical sectors formed in the track Tr0 of the head HD2 are all normal, and logical addresses 36 to 39 are assigned to them. The physical sectors formed in the track Tr1 of the head HD2 are all defective sectors, and logical addresses are not assigned to them. When similar assignments are continuously performed, since the sector of serial number 57 in the physical sectors formed in the track Tr4 of the head HD2 is a defective sector, logical addresses 52 to 55 are assigned to the three sectors except for the defective sector.

Next, since the sectors of serial numbers 61 and 62 in the physical sectors formed in the track Tr0 of the head HD3 are defective sectors, logical addresses 56 and 57 are assigned to the two sectors except for the defective sectors. The physical sectors formed in the track Tr1 of the head HD3 are all normal, and logical addresses 58 to 61 are assigned to them. When similar assignments are continuously performed, since the sector of serial number 77 in the physical sectors formed in the track Tr4 of the head HD3 is a defective sector, logical addresses 70 to 72 are assigned to the three sectors except for the defective sector.

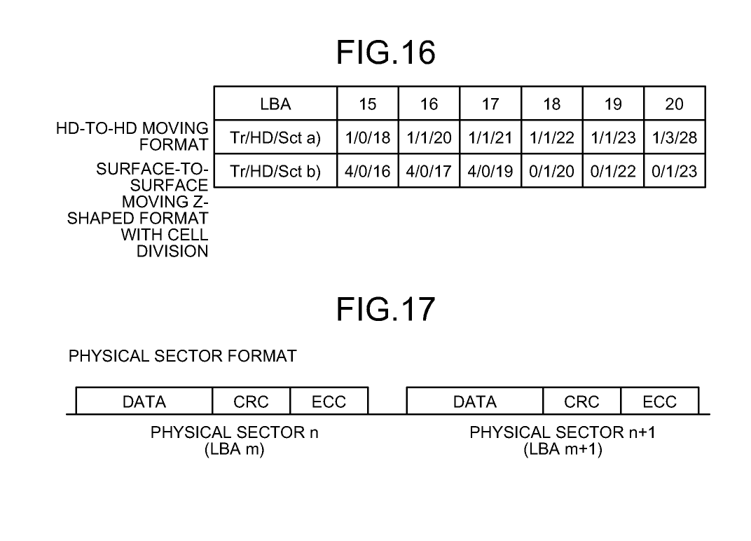

FIG. 16 illustrates a variation of assignment destinations of logical addresses depending on the difference in the format. In FIG. 16, using the logical addresses (LBA) 15 to 20 as an example, the physical sectors assigned to the logical addresses 15 to 20 in the head-to-head moving format illustrated in FIG. 14 and the physical sectors assigned to the logical addresses 15 to 20 in the surface-to-surface moving Z-shaped format separated for each cell which is illustrated in FIG. 15 are compared.

As illustrated in FIG. 16, while the logical address 15 corresponds to the 18th physical sector in the track Tr1 of the head HD0 in the head-to-head moving format, the logical address 15 corresponds to the 16th physical sector in the track Tr4 of the head HD0 in the surface-to-surface moving Z-shaped format with cell division.

Similarly, while the logical address 16 corresponds to the 20th physical sector in the track Tr1 of the head HD1 in the head-to-head moving format, the logical address 16 corresponds to the 17th physical sector in the track Tr4 of the head HD0 in the surface-to-surface moving Z-shaped format with cell division.

While the logical address 17 corresponds to the 21st physical sector in the track Tr1 of the head HD1 in the head-to-head moving format, the logical address 17 corresponds to the 19th physical sector in the track Tr4 of the head HD0 in the surface-to-surface moving Z-shaped format with cell division.

While the logical address 18 corresponds to the 22nd physical sector in the track Tr1 of the head HD1 in the head-to-head moving format, the logical address 18 corresponds to the 20th physical sector in the track Tr0 of the head HD1 in the surface-to-surface moving Z-shaped format with cell division.

While the logical address 19 corresponds to the 23rd physical sector in the track Tr1 of the head HD1 in the head-to-head moving format, the logical address 19 corresponds to the 22nd physical sector in the track Tr0 of the head HD1 in the surface-to-surface moving Z-shaped format with cell division.

While the logical address 20 corresponds to the 28th physical sector in the track Tr1 of the head HD3 in the head-to-head moving format, the logical address 20 corresponds to the 23rd physical sector in the track Tr0 of the head HD1 in the surface-to-surface moving Z-shaped format with cell division.

FIG. 17 illustrates the format of physical sectors. The physical sector is a data sector on the medium, and comprises a data section in which user data is stored, a CRC section having a seed value which is a logical address assigned by the format, and an ECC which is an error check & correction code generated from the data and the CRC.

In FIG. 17, LBA m is assigned to the physical sector n, and LBA m+1 is assigned to the physical sector n+1. Since the CRC of the physical sector n is a check code generated from the data stored in the data section by using the logical address (m) as a seed value, if data is read from a physical sector different from the sector in which the data is written, such as for example, if data is read when falsely recognizing that LBA m is LBA m+1, an CRC error occurs because the seed value of CRC is different.

As described above, according to the embodiment, a write access is made in the mode when the apparatus is formatted. On the other hand, when a read access is made, the access mode can be changed by a command. Therefore, for example, if a read access is not specified when the surface-to-surface moving Z-shaped format has been performed, the control firmware assigns logical addresses in a predetermined other format (for example, head-to-head moving format, etc.) and reads data. Thus, the control firmware cannot read correct data.

In this way, the logical access of the apparatus can be changed by only firmware control, and it is possible to prevent data leakage to a third person as well as to suppress the cost of the apparatus. Specifically, reverse engineering and unauthorized data access can be prevented, and differently from encryption or the like, dedicated hardware and also keyword management are not required. Thus, the magnetic storage apparatus 10 can be realized by a simple hardware and firmware configuration. Furthermore, since the magnetic storage apparatus 10 can be implemented by changing a firmware control, the actual cost does not increase. In addition, it is not necessary to add an additional security code to the medium, and thereby efficiency in the use of the medium does not decrease.

The above embodiment is described by way of example and not of limitation, and is susceptible to various changes or substitutions and modifications. For example, a specification is possible in which mode setting for reading is defined as a special command for each user and a third person cannot know the mode setting. In addition, when the access mode is allowed to be changed only once, the security can be further increased.

Furthermore, in the above embodiment, although an access mode of read access is changed and an access mode used for formatting is applied to write access, an access mode of write access maybe changed. Since the write operation of the above case is the same as the read operation of the embodiment, the description is omitted.

In the above embodiment, when the purchaser does not specify the access mode, the head-to-head moving format is selected for formatting and read operation. In this way, when the access mode is not specified, the magnetic storage apparatus can be used without security by matching the access mode of formatting with the access mode of read operation. However, as a modified example of the embodiment, a configuration may be such that the access mode of formatting is differentiated from that of read operation even when the access mode is not specified for secure use.

In the above embodiment, although the case where the access mode is specified by the formatting before shipping is described as an example, a user may specify the access mode and perform formatting after shipping.

Furthermore, although the storage apparatus of the above embodiment is described by way of example as the one using a magnetic disk as a storage medium, the storage apparatus may be an optical storage apparatus which uses an optical disk as a storage medium. In this case, the magnetic storage medium of the embodiment is replaced with, for example, a double-sided optical storage medium, or an optical storage medium in which a plurality of single-sided media are combined to be used, and the magnetic head of the embodiment is replaced with an optical head.

As set forth hereinabove, according to an embodiment of the invention, whether the read access mode matches the write access mode is detected to prevent unauthorized read. This improves confidentiality and security of data with a simple configuration.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An access control apparatus configured to convert a logical address into position information of a physical sector to control access to a storage medium, the access control apparatus comprising:
an access mode specifying command processing module configured to receive an access mode specifying command specifying an access mode that defines a relationship between the logical address and the physical sector, and store the access mode in an access mode storage module; and
an access processing module configured to refer to the access mode storage module to determine an access mode for accessing the storage medium.

2. The access control apparatus of claim 1, wherein the access mode defines an assignment order of logical addresses to physical sectors included in a plurality of recording surfaces of the storage medium.

3. The access control apparatus of claim 1, wherein the access processing module is configured to refer to the access mode when reading data from the storage medium, and write data to the storage medium based on a specific access mode.

4. The access control apparatus of claim 1, wherein the access mode storage module is a volatile memory.

5. The access control apparatus of claim 1, wherein the access processing module is configured to apply a specific access mode when the access mode storage module stores no access mode.

6. The access control apparatus of claim 1, wherein the storage medium is a magnetic disk comprising a plurality of magnetic recording surfaces and a plurality of magnetic heads corresponding to the magnetic recording surfaces.

7. An access control method for controlling access to a storage medium by converting a logical address into position information of a physical sector, the access control method comprising:
an access mode specifying command processing module receiving an access mode specifying command specifying an access mode that defines a relationship between the logical address and the physical sector, and storing the access mode in an access mode storage module; and
an access processing module referring to the access mode storage module to determine an access mode for accessing the storage medium.

8. The access control method of claim 7, wherein the access mode defines an assignment order of logical addresses to physical sectors included in a plurality of recording surfaces of the storage medium.

9. A storage apparatus comprising an access controller configured to convert a logical address specified by a host into position information of a physical sector to control an access request to a storage medium including a plurality of recording surfaces when receiving the access request from the host, the access controller comprising
an access mode specifying command processing module configured to receive an access mode specifying command specifying an access mode that defines a relationship between the logical address and the physical sector, and store the access mode in an access mode storage module; and
an access processing module configured to refer to the access mode storage module to determine an access mode for accessing the storage medium.

10. The storage apparatus of claim 9, wherein the access mode defines an assignment order of logical addresses to physical sectors included in a plurality of recording surfaces of the storage medium.
